(19) United States
(12) Patent Application Publication
(10) Pub. No.: US 2006/0203645 A1
(43) Pub. Date: Sep. 14, 2006

(54) Apparatus and method of determining a power parameter for writing/erasing information on an optical medium

(76) Inventors: Antonius Jacobus Josephus Van Den Hoogen, Eindhoven (NL); Cai Gang Xu, Singapore (SG)

Correspondence Address: PHILIPS INTELLECTUAL PROPERTY & STANDARDS, P.O. BOX 3001, BRIARCLIFF MANOR, NY, 10510, US

(21) Appl. No.: 10/547,327

(22) PCT Filed: Feb. 20, 2004
(86) PCT No.: PCT/IB04/00507

§ 371 Date: Aug. 30, 2005

(30) Foreign Application Priority Data
May 5, 2003 (EP) 03290529.1

(51) Int. Cl. G11B 7/12

(52) U.S. Cl. 369/47.53

(57) ABSTRACT

The invention relates to an apparatus and method of determining a value of a write/erase power parameter (Ptarget) for writing/erasing information on an optical recording medium by means of a radiation beam. The method is based on the curve-fitting of a function by a set of parameters a-b-c, said function establishing a relation between a product of the power level (P) of the radiation beam with a modulation factor (M) of the recorded signals, and the power level (P). The set of parameters are thus used for solving an equation establishing a relation between a gamma curve and the power level (P), the solution of said equation being considered as the optimum value of the write/erase power parameter (Ptarget). An optimum power level (Popt) can thus be derived from the write/erase power parameter (Ptarget). Use: writing/erasing of an optical recording medium.

### FIELD OF THE INVENTION

The invention relates to a method of determining a value of a write/erase power parameter for use in an optical recording apparatus for writing/erasing information on an optical recording medium by means of a radiation beam.

The invention also relates to an optical recording apparatus comprising means for determining a value of a write/erase power parameter of a radiation beam for writing/erasing information on an optical recording medium.

The invention may be used in the field of optical recording.

### BACKGROUND OF THE INVENTION

European patent application EP 0 737 962 discloses an optical recording apparatus comprising means for setting an optimum write power level of the radiation beam. This apparatus uses a method of setting the optimum write power level of the radiation beam having the following steps. First the apparatus records a series of test patterns of increasing write power on the recording medium. Next, it derives the modulation of each pattern from the read signal corresponding to the pattern. It calculates the derivative of the modulation as a function of the write power, and normalizes the derivative by multiplying it by the write power over the modulation. The obtained curve is known as normalized gamma curve, or γ curve. The intersection of the normalized gamma curve with a preset value γ_{target} determines a target write power parameter. Finally, the target write power parameter is multiplied by a parameter ρ to obtain a optimum write power level suitable for recording on the recording medium. The value of the parameter ρ is read from the recording medium itself. The test patterns are recorded on the recording medium in that write power values are applied in a range around a given value which is also read from the recording medium itself.

It is important in an optical recording apparatus to record information on optical recording media with the correct power of the laser beam. Similarly, the power of the laser beam for erasing the information on the recording media must be correct. A media manufacturer cannot give this correct power in an absolute way (e.g. pre-recorded on the disc) because of environmental and apparatus-to-apparatus deviations for every recording medium and recording apparatus combination. The known method of setting the optimum write power level takes the different characteristics of the recording media into account by measuring the modulation of the test patterns written on the recording media. The method is designed for providing a setting of the write power for each combination of recording apparatus and recording medium.

However, the known method leads to limitations since it is not always possible to determine an accurate and unambiguous value for the target write power parameter and therefore for the optimum write power level. This is because of the measurement noise introduced during the measurement of the values for the modulation of each pattern, the derivative operation amplifying the noise effect. This measurement noise increases with decreasing write power of the test patterns. It appears that even when the measured modulation values are averaged, so as to reduce the measurement noise, sometimes a kind of plateau in the γ curve occurs preventing the determination of an unambiguous value for the target write power parameter.

### OBJECT AND SUMMARY OF THE INVENTION

It is an object of the present invention to propose a method of determining an accurate and unambiguous value for a write/erase power parameter.

This object is achieved by the following recursive steps:
a first step 401 of writing a series of test patterns on the recording medium, each test pattern being written with a different value of a power level P of the radiation beam, the power level P having a variation range varying between a minimum power level Pₘᵢₙ and a maximum power level Pₘₐₓ,
a second step 402 of reading the test patterns on the recording medium for obtaining read signal portions,
a third step 403 of deriving a value of a read parameter M from each read signal portion, for defining a set of read parameters comprising a minimum read parameter Mₘᵢₙ,
a fourth step 404 of curve-fitting a function (f) defining a relation between a combination of the read parameter M with the power level P and the power level P, said function being characterized by a set of parameters a-b-c,
a fifth step 405 of checking conditions depending on said set of parameters a-b-c to be fulfilled by the maximum power level Pₘₐₓ, the minimum power level Pₘᵢₙ, and the minimum read parameter Mₘᵢₙ,
a sixth step 406 of modifying the variation range of the power level P if said conditions are not fulfilled, then going back to the first step 401,
a seventh step 407 of extracting, if said conditions are fulfilled, the value of said write/erase power parameter P_{target} from an equation having the power level P as a variable.

Instead of obtaining a direct derivation of the modulation parameter as done in the known method of determining the γ curve, the γ curve is here modeled by a generic equation characterized by the set of parameters. Thus, the presence of the noise is reduced in the calculation, which improves the accuracy in the determination of the write/erase power parameter. The write/erase power parameter is extracted from an equation corresponding to the modeled γ curve expressed by a set of parameters.

Preferably, this method includes an additional step of multiplying the write/erase power parameter by a multiplication constant for deriving an optimum write/erase power level of the radiation beam.

The multiplication constant is read from an area on the recording medium containing control information indicative of a recording process by which information can be recorded on said recording medium. The power of the radiation beam can thus be set accurately, leading to optimal writing and erasing operations.

Preferably, the read parameter is a modulation of the amplitude of the read signal portions.

The modulation calculation is indeed cost-effective for indicating the amplitude of said read signal portions.

Preferably, the curve-fitted function is a second-order curve of the form:
P*M=f(P)=c+b·P+a·P²

The use of a second-order curve is a good compromise between a processing complexity of modeling and a residual error between the theoretical curve and the real curve. Moreover, the parameters a-b-c can be determined, for example, via the least-squares algorithm which is easy to implement.

The write/erase power parameter is extracted from a second-order equation corresponding to the modeled γ curve expressed by parameters a-b-c. The conditions are fulfilled by a recursive process, and if they are fulfilled they allow to get a reliable single value of the write/erase power parameter in taking away negative and/or complex values.

The invention also relates to an optical recording apparatus comprising means for determining a value of a write/erase power parameter of a radiation beam for writing/erasing information on an optical recording medium. This optical recording apparatus comprises processing means for implementing the different steps of the method according to the invention.

The write/erase power of the laser beam perfectly matches the characteristics of the optical medium, which directly leads to minimize the jitter.

The invention also relates to a computer program comprising code instructions for implementing the steps of the method according to the invention.

Detailed explanations and other aspects of the invention will be given below.

### BRIEF DESCRIPTION OF THE DRAWINGS

The particular aspects of the invention will now be explained with reference to the embodiments described hereinafter and considered in connection with the accompanying drawings, in which identical parts or sub-steps are designated in the same manner:

FIG. 1 is a diagram of an embodiment of an optical recording apparatus according to the invention,

FIG. 2 is an example of a graph showing the product of the measured modulation and the write power, as a function of the write power, and well as the corresponding curve-fitted function,

FIG. 3 illustrates a read signal portion derived from a test pattern,

FIG. 4 is a flow-chart showing the different steps of the method according to the invention.

### DETAILED DESCRIPTION OF THE INVENTION

The normalized gamma γ curve can be expressed by the multiplication of two terms:
a first term corresponding to the derivative of M by P,
a second term corresponding to the ratio between M and P,
P being the power of the write/erase laser beam,
M being a read parameter indicating the amplitude of the signal written on the optical recording medium.

The gamma curve can thus be written as follows:

$$γ = \frac{ⅆ M}{ⅆ P} * \frac{M}{P} \qquad ( 1 )$$

The read parameter M is advantageously defined as the modulation factor of the information which is read on the optical recording medium.

The method according to the invention is based on the modeling of the relation between variables P*M and P. Indeed, it is assumed that the relation between P*M and P may be advantageously modeled by a second-order curve characterized by a set of parameters a-b-c as follows:

$$\begin{matrix}P * M = c + b \cdot P + a \cdot {P}^{2} \\ Thus \text{:} & ( 2 ) \\ M = \frac{c + b \cdot P + a \cdot {P}^{2}}{P} & ( 3 ) \\ \frac{ⅆ M}{ⅆ P} = \frac{a \cdot {P}^{2} - c}{{P}^{2}} & ( 4 ) \\ \frac{M}{P} = \frac{{P}^{2}}{c + b \cdot P + a \cdot {P}^{2}} & ( 5 )\end{matrix}$$

In substituting (4) and (5) in equation (1), the expression of the gamma curve can be expressed as follows:

$$γ = \frac{a \cdot {P}^{2} - c}{c + b \cdot P + a \cdot {P}^{2}} \qquad ( 6 )$$

where the coefficients a, b and c are to be determined from the measurement data during the Optimum Power Calibration (OPC) procedure known by the man skilled in the art.

The write/erase power parameter P_{target} is the particular value of P which verifies equation (6), assuming that γ=γ_{target}, so that:

$${γ}_{target} = \frac{a \cdot {P}_{target}^{2} - c}{c + b \cdot {P}_{target} + a \cdot {P}_{target}^{2}} \\ c \cdot ( 1 + {γ}_{target} ) + b \cdot {γ}_{target} \cdot {P}_{target} + a \cdot ( {γ}_{target} - 1 ) \cdot {P}_{target}^{2} = 0 \qquad ( 7 )$$

Therefore, the optimum write/erase power level Pₒₚₜ of the laser beam is calculated as follows:
Pₒₚₜ=ρ×P_{target} (8)

where ρ and γ_{target} are known parameters which can be read from the disc ATIP information (Absolute Time In Pre-groove for CDR/CDRW optical recording medium) or ADIP information (ADdress In Pre-groove for DVD+R/RW optical recording medium).

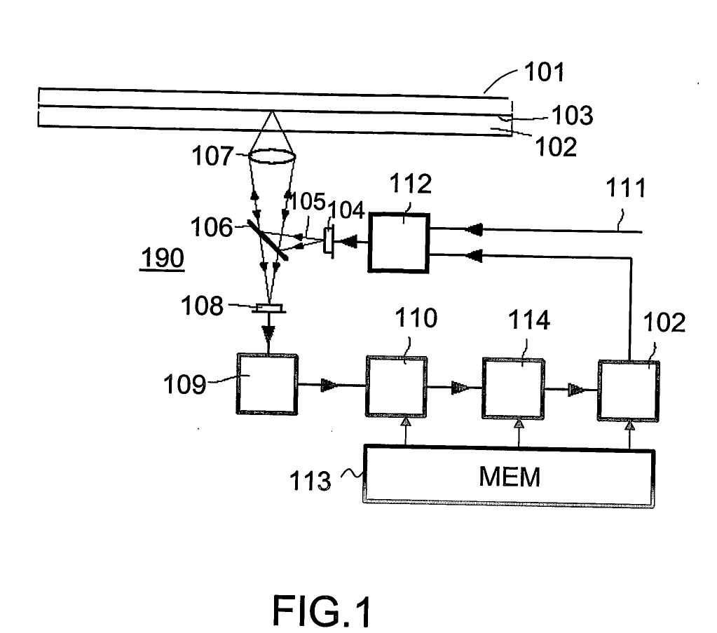

FIG. 1 shows an optical recording apparatus and an optical recording medium 101 according to the invention. Recording medium 101 has a transparent substrate 102 and a recording layer 103 arranged on it. The recording layer 103 comprises a material suitable for recording information by means of a radiation beam 105. The recording material may be, for example, of the magneto-optical type, the phase-change type, the dye type, or any other suitable material. Information may be recorded in the form of optically detectable regions, also called marks, on recording layer 103. The apparatus comprises a radiation source 104, for example a semiconductor laser, for emitting a radiation beam 105. The radiation beam is converged on recording layer 103 via a beam splitter 106, an objective lens 107, and substrate 102. The recording medium may alternatively be air-incident, where the radiation beam is directly incident on recording layer 103 without passing through a substrate. Radiation reflected from medium 101 is converged by objective lens 107 and, after passing through beam splitter 106, falls on a detection system 108, which converts the incident radiation into electric detector signals. The detector signals are input to a circuit 109. This circuit 109 derives several signals from the detector signals, such as a read signal S_{R} representing the information being read from recording medium 101. Radiation source 104, beam splitter 106, objective lens 107, detection system 108, and circuit 109 together form a read unit 190.

The read signal generated from circuit 109 is processed in a first processor 110 in order to derive signals representing a read parameter. The derived signals are fed into a second processor 114 and subsequently into a third processor 102, which processors process a series of values of the read parameter and based thereon derive a value for a write power control signal necessary for controlling the laser power level.

The write/erase power control signal is connected to a control unit 112. An information signal 111, representing the information to be recorded on the recording medium 101, is also fed into control unit 112. The output of control unit 112 is connected to radiation source 104. A mark on recording layer 103 may be recorded/erased by a single radiation pulse, the power of which is determined by the optimum write/erase power level Pₒₚₜ as determined by processor 102. Alternatively, a mark may also be recorded by a series of radiation pulses of equal or different lengths and one or more power levels determined by the write power signal.

A processor is understood to be any means suitable for performing calculations, e.g. a micro-processor, a digital signal processor, a hard-wired analog circuit, or a field programmable circuit. Moreover, first processor 110, second processor 114, and third processor 102 may be separate devices or, alternatively, may be combined into a single device executing all three processes. Processors 110-114-102 are connected to a memory 113 which stores code instructions in the form of a computer program. This memory is, for example, a memory of the flash ROM type.

Before writing/erasing information on medium 101, the apparatus sets its write power P to the optimum power level Pₒₚₜ by performing the method according to the invention.

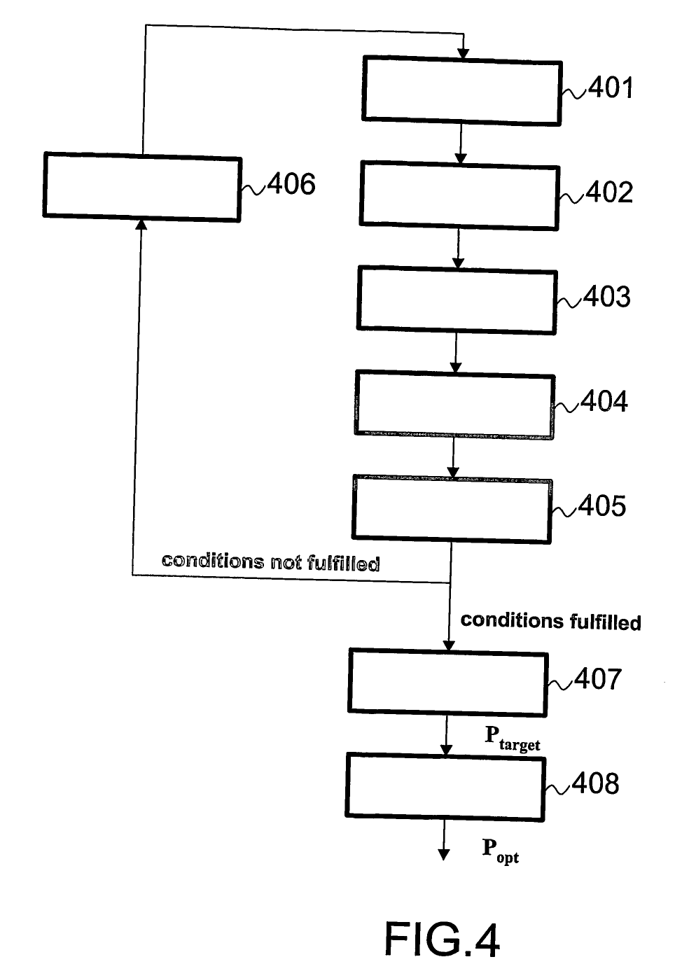

FIG. 4 is a flow-chart showing the different steps of the method according to the invention.

In a first step 401, the apparatus writes a series of test patterns on medium 101. The test patterns should be selected so as to give a desired read signal portion. If the read parameter to be derived from the read signal portion is the modulation M of said read signal portion, the test pattern should comprise marks sufficiently long to achieve a maximum modulation of the read signal portion. However, apart from the fact that test patterns must present some temporal variations so that a modulation parameter can be determined, there is no particular constraint as regards the shapes of such test signals. A random test pattern having temporal variations may thus be used.

If the information is coded according to the so-called Eight-to-Fourteen Modulation (EFM), the test patterns preferably comprise the long I11 marks of the modulation scheme. If the information is coded according to the Eight-to-Fourteen Plus Modulation (EFM+), the test patterns should comprise the long I14 marks of this modulation scheme.

Each test pattern is written with a different value of a power level P of the radiation beam, the value of the power level P varying between a minimum power level Pₘᵢₙ and a maximum power level Pₘₐₓ, with an incremental step size ΔP.

The test patterns are preferably written in specially provided test areas on the recording medium. In particular, a first test area is composed of three sets of seven ADIP/ATIP frames. In that case, the test area covers one revolution of the disc and is capable of defining a set of 21 different values of the power level P. The power level Pᵢ associated to the test pattern of rank (i) is then expressed by Pᵢ=Pₘᵢₙ+i*ΔP, for i=0 to 20.

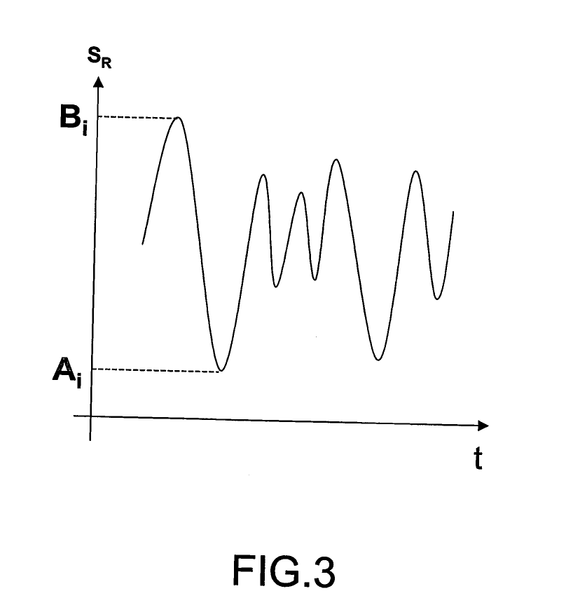

In a second step 402, the recorded test patterns are read by read unit 190 to form read signal portion S_{R}. FIG. 3 shows a read signal portion obtained from a test pattern.

In a third step 403, processor 110 derives a value of a read parameter M for each read signal portion S_{R}. According to FIG. 3, a preferred read parameter is the modulation M defined as the ratio of two terms:
a first term corresponding to the maximum peak-to-peak value (Bᵢ−Aᵢ) of a read signal portion,
a second term corresponding to the maximum amplitude Bᵢ of the read signal portion.

The modulation factor Mᵢ associated with the test pattern of rank (i) is then expressed as follows:
Mᵢ=(Bᵢ−Aᵢ)/Bᵢ
The minimum read parameter among the set of read parameters Mᵢ is referred to as Mₘᵢₙ.

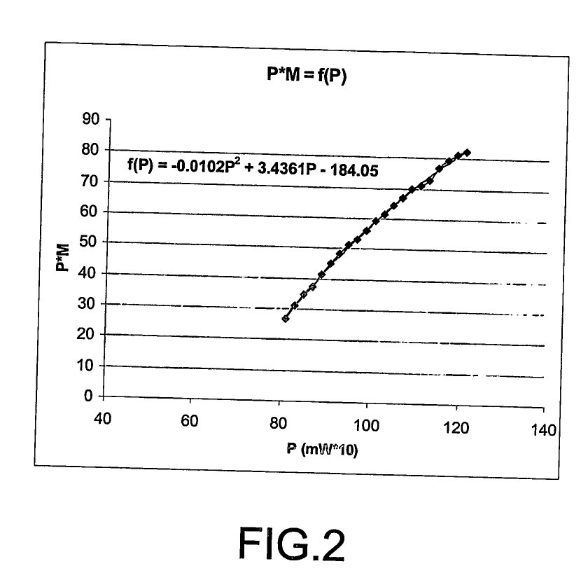

In a fourth step 404, processor 114 forms a series of value pairs (P*M, P) for the modulation M of a pattern times the write power P and the write power P with which that pattern has been written. This series of value pairs defines a function (f) verifying the relation P*M=f(P) to be modeled by a curve-fitting step, said function being characterized by a set of parameters a-b-c as expressed in (2). FIG. 2 schematically shows a non-limitative example of the result of the processed read signal obtained from the test patterns. Each data point defining the function f represents a pair of values for the modulation M times the write power P and the write power P of a test pattern. Processor 114 fits a second-order curve for defining the analytic of expression of the relation (2), i.e. the value of parameters a-b-c. The fitted curve is indicated in FIG. 2 by a solid line. The fitting may be done by the well-known least-squares fitting algorithm.

In a fifth step 405, processor 102 checks conditions to be fulfilled by the maximum power level Pₘₐₓ, the minimum power level Pₘᵢₙ, and the minimum read parameter Mₘᵢₙ. These conditions aim to take away incorrect solutions for the write/erase power parameter P_{target} in the resolution of equation (7), in particular in taking away negative solutions, complex solutions, or dual real solutions. The conditions to be fulfilled lead to a single value for P_{target} which is real and positive. The conditions to be fulfilled are expressed as follows:
the condition to be fulfilled by the maximum power level Pₘₐₓ is expressed by the relation

$$\frac{a \cdot {P}_{max}^{2} - c}{c + b \cdot {P}_{max} + a \cdot {P}_{max}^{2}} \leq {γ}_{target} \qquad ( 9 )$$
the condition to be fulfilled by the minimum power level Pₘᵢₙ is expressed by the relation

$$\frac{a \cdot {P}_{min}^{2} - c}{c + b \cdot {P}_{min} + a \cdot {P}_{min}^{2}} \geq {γ}_{target} \qquad ( 10 )$$
the condition to be fulfilled by the minimum read parameter Mₘᵢₙ is expressed by the relation
   Mₘᵢₙ≧M₀ (11)

where γ_{target} is the target parameter of the gamma curve read on the recording medium, and M₀ is a fixed parameter derived from a measurement noise level of the read signal portions. For example, M₀ is set to 15/100.

If the above-mentioned conditions are not fulfilled, the method goes back to the first step 401 via a sixth step 406 which modifies the variation range of the power level P for the writing of the test patterns. For example, the variation range may be modified by increasing or decreasing the value of minimum power level Pₘᵢₙ. The modification of the variation range may be done in loading new values from the memory 113. Then, the method continues in repeating the steps of writing test patterns, reading test patterns, deriving parameter M, curve-fitting, until the conditions are fulfilled. If the conditions are not fulfilled, the method goes on with a seventh step 407.

In a seventh step 407, processor 102 extracts the write/erase power parameter P_{target} which is the solution of an equation having the power level P as a variable. This equation is given by the equation (7) in which parameters a-b-c are replaced by their values derived from the curve-fitting.

The resolution of equation (7) may be performed by a classic algorithm for solving second-order equations.

Alternatively, the resolution of equation (7) may be performed via a cost-effective and fast recursive algorithm. In that case, two intermediate variables Q1 and Q2 are introduced:
Q₁=γ_{target}·(c+b·P+a·P²) (12)
and
Q₂=a·P²−c (13)

Using these two intermediate variables, the write/erase power parameter P_{target} is the value of the power level Pᵢ used during the writing of the test pattern having rank i, which minimizes the distance between Q1 and Q2, for example which minimizes the function |Q1−Q2|.

Alternatively, the write/erase power parameter P_{target} may derive from the following equation:

$${P}_{target} = {P}_{i 0} - \frac{Δ P \cdot ( {γ}_{target} - {γ}_{i 0} )}{{γ}_{i 0 - 1} - {γ}_{i 0}} \qquad ( 14 )$$

where i0 is the particular value of the index i taken from the set (0 . . . 20) which verifies the relation γᵢ₋₁>γ_{target}≧γᵢ, with γᵢ calculated from equation (6) assuming that P=Pᵢ.

In a additional step 408, according to equation (8), the write/erase power parameter P_{target} is multiplied by a constant ρ for deriving an optimum write/erase power level Pₒₚₜ of the radiation beam 105.

Preferably, the above process of writing and reading test patterns is done successively in three additional test areas each composed of three sets of seven ADIP/ATIP frames. These test areas are rotated 120 degrees with respect to each other in order to minimize the effect of the non-homogeneousness in the tangential direction. In each area, the test patterns are written with a write power level P varying in different ranges, the extremes of such ranges also satisfying the conditions expressed by relations (9), (10) and (11). Then, three different intermediate values of P_{target} are obtained, said different intermediate values being thus averaged to get the final value of the write/erase power parameter P_{target} to be used for deriving the optimum write/erase power level Pₒₚₜ as described below.

This method may be advantageously used in an optical recording apparatus for writing/erasing information on an optical recording medium 101 by means of a radiation beam 105 having a power level P, the optimum write/erase power level Pₒₚₜ of the power P of the radiation beam being set by first determining the value of the write/erase power parameter P_{target} from the method according to the invention. Said apparatus thus comprises the following means applied recursively:
a control unit 112 for writing a series of test patterns on the recording medium, each test pattern having a different value of a power level P of the radiation beam, the value of the power level P having a variation range varying between a minimum power level Pₘᵢₙ and a maximum power level Pₘₐₓ,
a read unit 190 for reading the test patterns on the recording medium for obtaining read signal portions,
first means 110 for deriving a value of a read parameter M from each read signal portion so as to define a set of read parameters comprising a minimum read parameter Mₘᵢₙ,
second means 114 for curve-fitting a function (f) defining a relation between a combination of the read parameter M with the power level P and the power level P, said function being characterized by a set of parameters a-b-c,
third means 102 for:
   a) checking conditions depending on said set of parameters a-b-c to be fulfilled by the maximum power level Pₘₐₓ, the minimum power level Pₘᵢₙ, and the minimum read parameter Mₘᵢₙ,
   b) modifying the variation range of the power level P if said conditions are not fulfilled, then the processing going back to the processing performed by the control unit 112,
   c) extracting, if said conditions are fulfilled, the value of said write/erase power parameter P_{target} from an equation having the power level P as a variable.

This apparatus further comprises means 102 for multiplying the write/erase power parameter P_{target} by a multiplication constant ρ for deriving an optimum write/erase power level Pₒₚₜ of the radiation beam 105.

This multiplication constant ρ is read by the read unit 190 from an area on the recording medium containing control information indicative of a recording process by which information can be recorded on that recording medium, as expressed in equation (8).

The steps of the methods may be implemented by means of hardware elements (such as wired electronic circuits, memories, signal processors . . . ), or alternatively, by means of software elements such as computer programs comprising code instructions stored in a memory device (such as a ROM memory), said code instructions being executed by one or a plurality of signal processors. Such a computer program may be stored in memory 113 of FIG. 1.

Although explanations have been given based on the use of the read signal modulation M as read parameter, it will be clear to those skilled in the art that other read parameters expressing the signal amplitude may be used in the invention.

The words “comprise”, “comprises” and “comprising” do not exclude the presence of elements other than those listed in the claims.

1. A method of determining a value of a write/erase power parameter (P_{target}) for use in an optical recording apparatus for writing/erasing information on an optical recording medium (101) by means of a radiation beam (105), the method comprising the following recursive steps :
a first step (401) of writing a series of test patterns on the recording medium, each test pattern being written with a different value of a power level (P) of the radiation beam, the power level (P) having a variation range varying between a minimum power level (Pₘᵢₙ) and a maximum power level (Pₘₐₓ),
a second step (402) of reading the test patterns on the recording medium for obtaining read signal portions,
a third step (403) of deriving a value of a read parameter (M) from each read signal portion, for defining a set of read parameters comprising a minimum read parameter (Mₘᵢₙ),
a fourth step (404) of curve-fitting a function (f) defining a relation between a combination of the read parameter (M) with the power level (P) and the power level (P), said function being characterized by a set of parameters (a, b, c),
a fifth step (405) of checking conditions depending on said set of parameters (a, b, c) to be fulfilled by the maximum power level (Pₘₐₓ), the minimum power level (Pₘᵢₙ), and the minimum read parameter (Mₘᵢₙ),
a sixth step (406) of modifying the variation range of the power level (P) if said conditions are not fulfilled, then going back to the first step (401),
a seventh step (407) of extracting, if said conditions are fulfilled, the value of said write/erase power parameter (P_{target}) from an equation having the power level (P) as a variable.

2. A method as claimed in claim 1, wherein the read parameter (M) is a modulation of the amplitude of the read signal portions.

3. A method as claimed in claim 1, wherein the curve-fitted function (f) is a second-order curve of the form P*M=f(P)=c+b·P+a·P².

4. A method as claimed in claim 1, wherein:
the condition to be fulfilled by the maximum power level (Pₘₐₓ) is expressed by the relation
$$\frac{a \cdot {P}_{max}^{2} - c}{c + b \cdot {P}_{max} + a \cdot {P}_{max}^{2}} \leq {γ}_{target}$$
the condition to be fulfilled by the minimum power level (Pₘᵢₙ) is expressed by the relation
$$\frac{a \cdot {P}_{min}^{2} - c}{c + b \cdot {P}_{min} + a \cdot {P}_{min}^{2}} \geq {γ}_{target}$$
the condition to be fulfilled by the minimum read parameter (Mₘᵢₙ) is expressed by the relation Mₘᵢₙ≧M₀
where γ_{target} is a parameter read on the recording medium, and M₀ is a parameter derived from a measurement noise level of the read signal portions.

5. A method as claimed in claim 1, further including an additional step (408) of multiplying the write/erase power parameter (P_{target}) by a multiplication constant (ρ) for deriving an optimum write/erase power level (Pₒₚₜ) of the radiation beam (105).

6. An optical recording apparatus for determining a value of a write/erase power parameter of a radiation beam (105) for writing/erasing information on an optical recording medium (101), said optical recording apparatus also comprising the following means applied recursively:
a control unit (112) for writing a series of test patterns on the recording medium, each test pattern having a different value of a power level (P) of the radiation beam, the value of the power level (P) having a variation range varying between a minimum power level (Pₘᵢₙ) and a maximum power level (Pₘₐₓ),
a read unit (190) for reading the test patterns on the recording medium for obtaining read signal portions,
first means (110) for deriving a value of a read parameter (M) from each read signal portion so as to define a set of read parameters comprising a minimum read parameter (Mₘᵢₙ),
second means (114) for curve-fitting a function (f) defining a relation between a combination of the read parameter (M) with the power level (P) and the power level (P), said function being characterized by a set of parameters (a, b, c),
third means (102) for:
a) checking conditions depending on said set of parameters (a, b, c) to be fulfilled by the maximum power level (Pₘₐₓ), the minimum power level (Pₘᵢₙ), and the minimum read parameter (Mₘᵢₙ),
b) modifying the variation range of the power level (P) if said conditions are not fulfilled, then the processing going back to the processing performed by the control unit (112),
c) extracting, if said conditions are fulfilled, the value of said write/erase power parameter (P_{target}) from an equation having the power level (P) as a variable.

7. An optical recording apparatus as claimed in claim 6, further comprising means (102) for multiplying the write/erase power parameter (P_{target}) by a multiplication constant (ρp) for deriving an optimum write/erase power level (Pₒₚₜ) of the radiation beam (105).

8. A computer program comprising code instructions for implementing the steps of the method as claimed in claim 1.
